(19) United States
(12) Patent Application Publication
(10) Pub. No.: US 2023/0249435 A1
(43) Pub. Date: Aug. 10, 2023

(54) Multi-Layered Thermal Insulation System for Battery Pack Temperature Retention

(71) Applicant: Zephyros, Inc., Romeo, MI (US)

(72) Inventor: Manish Taxak, Pune, Maharashtra (IN)

(21) Appl. No.: 18/015,608

(22) PCT Filed: Sep. 3, 2021
(86) PCT No.: PCT/US2021/048966

§ 371 Date: Jan. 11, 2023

Related U.S. Application Data
(60) Provisional application No. 63/074,691, filed on Sep. 4, 2020.
(60) Provisional application No. 63/106,458, filed on Oct. 28, 2020.

(51) Int. Cl. B32B 5/02; B32B 15/20; B32B 15/14; B32B 5/26; B32B 17/06; B32B 9/04; B32B 9/00

(52) U.S. Cl. CPC B32B 5/022; B32B 15/20; B32B 15/14; B32B 5/26; B32B 17/067; B32B 9/047; B32B 9/005; B32B 2262/0246; B32B 2262/101; B32B 2307/304; B32B 2457/10; B32B 2262/105

(57) ABSTRACT

An insulation material having three or more layers, the layers including a metallic facing; and one or more nonwoven layers. One or more of the layers may be a needle punched layer. Each nonwoven layer may have a temperature resistance of about 400° C. or greater. The insulation material may be used for surrounding and insulating a battery, such as a battery for an electric vehicle.

### CLAIM OF BENEFIT OF FILING DATE

This application claims the benefit of U.S. Provisional Application No. 63/074,691, filed Sep. 4, 2020, and U.S. Provisional Application No. 63/106,458, filed Oct. 28, 2020, the contents of which are hereby incorporated by reference in their entireties.

### FIELD

The present teachings relate generally to a fibrous material for providing insulation, and more particularly, to a nonwoven fibrous material structure for providing thermal insulation for a battery.

### BACKGROUND

As the world is becoming more environmentally conscious, electric vehicles are gaining much attention. Countries around the world are investing in electric mobility-based initiatives, promoting manufacturing and use of electric and hybrid vehicles. Electric vehicles are powered, at least in part, by batteries. These batteries are rechargeable and are designed to power a vehicle over long periods of time, distances, or both. Mass transportation vehicles, such as vans and buses, also are increasingly including electric options.

These batteries, however, experience significant temperature fluctuations. The life of a battery degrades over time as a function of the magnitude and frequency of these temperature fluctuations. Standalone battery systems may, for example, experience a fluctuation (e.g., an increase) in temperature of about 50° C. or greater due to different vehicle and environmental conditions, which can result in early discharge of the battery. In attempts to keep the temperatures of these batteries regulated, the vehicles include active temperature control systems. However, these active temperature control systems use energy, and if this energy usage is high, such as in adverse environmental conditions, this greatly reduces the range of the vehicle. Batteries being considered and designed for future use are operated at even higher temperatures than current battery packs, and these batteries need to be kept at particular temperatures.

It is desirable, therefore, to provide a battery insulation system that reduces temperature fluctuations, maintains battery temperature (e.g., within about 25° C.), improves battery life cycle, or a combination thereof. It is desired to insulate a battery or other item requiring insulation to reduce the amplitude, and thus the impact, of temperature fluctuations to enhance the longevity of the battery or other item to be insulated. It is also desired to reduce the amount of time the battery or other item to be insulated experiences extreme temperatures, such as the highest or lowest temperature of the temperature fluctuations. By reducing the temperature fluctuations, the time the battery or item to be insulated sees extreme temperatures may also be less (e.g., the time above or below a certain extreme temperature should be less).

### SUMMARY

The present teachings meet one or more of the above needs by the improved devices and methods described herein. The present teachings provide improved insulation through a multi-layer structure. The multi-layer structure may provide insulation for a battery, such as a battery for an electric vehicle. The multi-layer structure may be a passive heat insulation product. The multi-layer structure may assist in maintaining generally constant temperature of the battery. The multi-layer structure may assist in reducing energy required to maintain battery temperatures. The multi-layer structure may be used in combination with an active temperature control system (e.g., an active heating system, an active cooling system, or an active heating/cooling system). For example, the multi-layer structure may reduce the energy required by an active temperature control system as compared with a battery and active temperature control system without the multi-layer structure.

The multi-layer structure may include three or more layers. The multi-layer structure may have six or fewer layers. The layers may include a metallic facing layer and one or more nonwoven layers. One or more of the layers may be a needle punched layer. Each nonwoven layer may have a temperature resistance of about 400° C. or greater. The metallic facing may be an aluminum foil. The aluminum foil may be a reinforced aluminum foil. The metallic facing may be an aluminum mesh. One or more of the nonwoven layers may include inorganic fibers. The inorganic fibers may be present in the layer in an amount of about 50 wt % or greater, about 75 wt % or greater, about 97 wt % or greater, or in an amount up to 100 wt % of the layer. One or more of the nonwoven layers may include organic fibers. The organic fibers may be present in the layer in an amount of about 50 wt % or greater, about 75 wt % or greater, about 97 wt % or greater, or in an amount up to 100 wt % of the layer. One or more of the nonwoven layers may include polyacrylonitrile fibers and/or oxidized polyacrylonitrile fibers.

One or more of the layers of the multi-layer structure may be the same as a layer directly adjacent. One or more of the layers of the multi-layer structure may be different from a layer directly adjacent. The layers may include any of the following in any combination: a metallized layer, a layer formed of oxidized polyacrylonitrile fibers, a needlepunched layer, a cross-lapped layer, a layer formed of organic fibers, a layer formed of inorganic fibers, an E-glass layer, an E-CR glass layer, a wetlaid layer, a high silica nonwoven layer, a ceramic blanket, a black glass cloth layer, a vertically lapped layer. At least one of the layers may have a temperature resistance of about 450° C. or greater, about 500° C. or greater, about 600° C. or greater, or about 700° C. or greater. One or more of the layers may have a temperature resistance of about 1300° C. or less.

The multi-layer structure may include, for example, an aluminum foil layer; one or more needle punched layers including polyacrylonitrile fibers and/or oxidized polyacrylonitrile fibers; and one or more cross-lapped layers including polyacrylonitrile fibers and/or oxidized polyacrylonitrile fibers.

The multi-layer structure may include, for example, an aluminum foil layer; one or more needle punched layers including polyacrylonitrile fibers and/or oxidized polyacrylonitrile fibers; one or more ceramic blanket layers; and one or more high-silica nonwoven layers.

The multi-layer structure may include, for example, an aluminum foil layer; one or more needle punched layers including polyacrylonitrile fibers and/or oxidized polyacrylonitrile fibers; and one or more E-glass layers.

The multi-layer structure may include, for example, an aluminum foil layer; one or more E-glass layers, one or more E-CR glass layers; and one or more black glass cloth layers.

The multi-layer structure may include, for example, an aluminum foil layer; one or more needlepunched layers including oxidized polyacrylonitrile fibers; one or more wetlaid layers; and one or more E-glass layers.

The multi-layer structure may form an insulation material for a battery. The battery may be a battery for an electric vehicle. The insulation material may include a top cover portion that extends generally co-planar with a face of the battery. The material may include one or more sides extending generally co-planar with a side of the battery. One or more side portions may include one or more cutouts to accommodate features of the battery.

The insulation material may be located under or within the confines of a cover (e.g., a top cover) of a battery within the vehicle.

The insulation material may be a passive insulation product. The passive insulation product may be used in combination with an active temperature control system to maintain proper battery temperature (e.g., within about 50° C., about 35° C., or about 25° C.).

The insulation material as described herein reduces temperature fluctuations, maintains battery temperature (e.g., within about 25° C.), improves battery life cycle, or a combination thereof. The insulation material as described herein may reduce the energy required by an active temperature control system to maintain proper battery temperature. The insulation material, therefore, may maintain, increase, or minimize negative effects on range of an electric vehicle (e.g., due to increased energy usage by active temperature control systems, such as an active heating and/or cooling system) as compared to an electric vehicle without the insulation material.

### DESCRIPTION OF THE DRAWINGS

FIG. 1 is an exploded view of a battery box assembly in accordance with the present teachings.

FIG. 2 is a view of a battery cover in accordance with the present teachings.

FIG. 3 is a cross-sectional view of an exemplary multi-layer insulator material in accordance with the present teachings.

FIG. 4 is an exemplary arrangement of layers of a multi-layer insulator material in accordance with the present teachings.

FIG. 5 is an exemplary arrangement of layers of a multi-layer insulator material in accordance with the present teachings.

FIG. 6 is an exemplary arrangement of layers of a multi-layer insulator material in accordance with the present teachings.

FIG. 7 is an exemplary arrangement of layers of a multi-layer insulator material in accordance with the present teachings.

FIG. 8 is an exemplary arrangement of layers of a multi-layer insulator material in accordance with the present teachings.

FIG. 9 is an exemplary arrangement of layers of a multi-layer insulator material in accordance with the present teachings.

FIG. 10 is an exemplary arrangement of layers of a multi-layer insulator material in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Insulation materials, such as fibrous structures, may have a wide range of applications, such as in automotive applications, generator set engine compartments, commercial vehicle engines, in-cab areas, construction equipment, agriculture equipment, architectural applications, flooring, floormat underlayments, and even heating, ventilating and air conditioning (HVAC) applications. Insulation materials may be used for machinery and equipment insulation, motor vehicle insulation, domestic appliance insulation, dishwashers, and commercial wall and ceiling panels. Insulation material may be used in an engine cavity of a vehicle, on the inner and/or outer dash panels, or under the carpeting in the cabin, for example. Insulation materials may also provide other benefits, such as sound absorption, compression resiliency, stiffness, structural properties, and protection (e.g., to an item around which the insulation material is located).

The present teachings envision the use of a fibrous structure for providing insulation. The fibrous structure may be a multi-layer insulator material. For example, the fibrous structure as described herein may be at least partially formed or wrapped around a battery or another item to be insulated. The fibrous structure as described herein may be located under a battery cover. The fibrous structure may be shaped to surround a plurality of sides of the battery, battery case, or other item to be insulated. The fibrous structure may be shaped to be located within a desired area of a vehicle, such as under a battery cover. The fibrous structure may be adapted to provide insulation to a solid-state battery, lithium ion battery, or other type of battery. The fibrous structure may be assembled into a box-type structure for surrounding a battery. The fibrous structure may be used with a battery of an electric vehicle.

The fibrous structure may be formed into the shape of a box or other enclosure. The fibrous structure may be formed into a shape capable of being located under a battery cover. The fibrous structure may be moldable or otherwise shaped. The fibrous structure may allow for mechanical features to be in-situ molded, may allow for fastening or assembly mechanisms to be included, or both. The fibrous structure may have folding and/or bending functionality (e.g., to allow the structure to be secured around the item to be insulated or within the confines of the area to which it is positioned).

The fibrous structure may be used as a passive heat insulation product. The fibrous structure may be used in combination with an active temperature control system. The fibrous structure may act to reduce the energy required by the active temperature control system to maintain proper battery temperature. The fibrous structure may allow the active temperature control system to work less, or less hard, to maintain proper battery temperature. The fibrous structure may help maintain, increase, or minimize negative effects on range of the vehicle as compared with a battery system and active temperature control system without the fibrous structure. An “active temperature control system” may be, for example, an active cooling system, an active heating system, or an active heating/cooling system, all of which are within the scope of the present teachings.

The fibrous structure may act as insulation for occupants of the vehicle. As batteries of electric vehicles may operate at high temperatures, and such temperatures are undesirable within the vehicle interior, the fibrous structure may serve as a first insulation material, keeping the elevated temperatures in the area of the battery. Without acting as an insulator for the vehicle interior, the interior cooling system (e.g., HVAC system) would have to work harder, and the energy consumption required to cool the vehicle would lower the range of the vehicle.

While batteries are specifically referenced herein, it is to be understood that the fibrous structure disclosed herein can be used to provide insulation to other items, and this disclosure is not limited to use with batteries or only certain types of batteries. For example, other applications may include, but are not limited to, in-cabin insulation and/or external heat shielding for transportation and off-highway vehicles; thermoacoustic insulation in generator sets, air compressors, HVAC units, or other stationary or mobile mechanical unit where heat or noise is generated.

The fibrous structure may function to provide insulation, acoustic absorption, structural support and/or protection to the item around which the fibrous structure is formed or positioned. The fibrous structure can be adjusted based on the desired properties. For example, the fibrous structure may be tuned to provide a desired weight, thickness, compression resistance, or other physical attributes. The fibrous structure may be tuned to provide a desired thermal conductivity. The fibrous structure may be tuned to withstand elevated temperatures, exposure to flame, smoke, or toxicity, or a combination thereof.

The fibrous structure may be formed from or may include nonwoven fibers. The fibrous structure may thus be a nonwoven structure. While referred to herein as the “fibrous structure,” it is contemplated that any of the individual layers may have any or all of these properties or characteristics. Also, while referred to herein as a “fibrous structure,” not all layers must be formed of fibers. It is contemplated that other materials, such as films, foils, adhesives, or other layers may be present in the fibrous structure.

The fibrous structure may be adapted to withstand high temperatures. One or more of the layers of the fibrous structure may have a temperature resistance of about 400° C. or greater, about 450° C. or greater, about 500° C. or greater, about 600° C. or greater, or about 700° C. or greater. One or more layers of the fibrous structure may have a temperature resistance of about 2500° C. or less, about 2000° C. or less, or about 1000° C. or less. The fibrous structure may be adapted to reduce temperature fluctuations experienced by the battery or item being insulated. The fibrous structure may provide thermal insulation for maintaining battery temperature (e.g., within about 15° C., about 20° C., about 25° C., about 35° C., or about 45° C.). The fibrous structure may serve as a fireblocker. The fibrous structure may block fire from extending beyond the enclosure of the fibrous structure (e.g., keeping fire from spreading should the battery catch fire). The fibrous structure may block fire from entering the enclosure of the fibrous structure (e.g., keeping fire from reaching the battery). The fibrous structure may be flame retardant. The fibrous structure may meet UL 94V-0, V-1, or V-2 flammability specifications (e.g., depending upon the application, required standards, or the like).

The fibers forming any of the layers of the fibrous structure may be natural or synthetic fibers. Suitable natural fibers may include cotton, jute, wool, cellulose, glass, and ceramic fibers. Suitable synthetic fibers may include polyester, polypropylene, polyethylene, Nylon, aramid, imide, acrylate fibers, or combination thereof. One or more layers of the fibrous structure may comprise polyester fibers, such as polyethylene terephthalate (PET), polybutylene terephthalate (PBT), and co-polyester/polyester (CoPET/PET) adhesive bi-component fibers. The fibers may include polyacrylonitrile (PAN), oxidized polyacrylonitrile (Ox-PAN, OPAN, or PANOX), olefin, polyamide, polyetherketone (PEK), polyetheretherketone (PEEK), polyether sulfone (PES), or other polymeric fibers. The fibers may include mineral or ceramic fibers. The fibers may be formed of any material that is capable of being carded, lapped, thermoformed, needlepunched, air laid, or other processing methods. The fibers may be formed of any material that is capable of being formed or shaped into a three-dimensional structure. The fibers may be 100% virgin fibers, or may contain fibers regenerated from postconsumer waste (for example, up to about 90% fibers regenerated from postconsumer waste or even up to 100% fibers regenerated from postconsumer waste). The fibers may have or may provide improved thermal insulation properties. The fibers may have relatively low thermal conductivity. The fibers may have geometries that are non-circular or non-cylindrical to alter convective flows around the fiber to reduce convective heat transfer effects within the three-dimensional structure. One or more layers of the fibrous structure may include or contain engineered aerogel structures to impart additional thermal insulating benefits.

The fibers forming one or more layers of the fibrous structure may include an inorganic material. The inorganic material may be any material capable of withstanding temperatures of about 250° C. or greater, about 400° C. or greater, about 500° C. or greater, about 750° C. or greater, about 1000° C. or greater. The inorganic material may be a material capable of withstanding temperatures up to about 1200° C. (e.g., up to about 1150° C.). The inorganic fibers may have a limiting oxygen index (LOI) via ASTM D2836 or ISO 4589-2 for example that is indicative of low flame or smoke. The LOI of the inorganic fibers may be higher than the LOI of standard binder fibers. For example, the LOI of standard PET bicomponent fibers may be about 20 to about 23. Therefore, the LOI of the inorganic fibers may be about 23 or greater. The inorganic fibers may have an LOI that is about 25 or greater. The inorganic fibers may be present in one or more of the layers of the fibrous structure in an amount of about 60 percent by weight or greater, about 70 percent by weight or greater, about 80 percent by weight or greater, or about 90 percent by weight or greater. The inorganic fibers may be present in one or more of the layers of the fibrous structure in an amount of about 100 percent by weight or less. The inorganic fibers may be selected based on its desired stiffness. The inorganic fibers may be crimped or non-crimped. Non-crimped organic fibers may be used when a fiber with a larger bending modulus (or higher stiffness) is desired. Where a fiber is needed to bend more easily, a crimped fiber may be used. The inorganic fibers may be ceramic fibers, glass fibers, mineral-based fibers, or a combination thereof. Ceramic fibers may be formed from polysilicic acid (e.g., Sialoxol or Sialoxid), or derivatives of such. For example, the inorganic fibers may be based on an amorphous aluminum oxide containing polysilicic acid. Siloxane, silane, and/or silanol may be added or reacted into one or more layers of the fibrous structure to impart additional functionality. These modifiers could include carbon-containing components.

The fibers, or at least a portion of the fibers, may have high infrared reflectance or low emissivity. At least some of the fibers may be metallized to provide infrared (IR) radiant heat reflection. An entire layer of the material may be infrared reflective. To provide heat reflective properties to and/or protect one or more of the layers of the fibrous structure, the fibers or one or more layers (or a portion thereof) of the fibrous structure may be metalized. For example, fibers may be aluminized. The fibers themselves may be infrared reflective (e.g., so that an additional metallization or aluminization step may not be necessary). The layers themselves may be infrared reflective. Metallization or aluminization processes can be performed by depositing metal atoms onto the fibers and/or one or more layers of the fibrous structure. As an example, aluminization may be established by applying a layer of aluminum atoms to the surface of fibers. Metalizing may be performed prior to the application of any additional layers one or more of the layers of the fibrous structure. It is contemplated that other layers of the fibrous structure may include metallized fibers in addition to, or instead of, having metallized fibers within the layer.

The metallization may provide a desired reflectivity or emissivity. The metallized fibers may be about 50% IR reflective or more, about 65% IR reflective or more, or about 80% IR reflective or more. The metallized fibers may be about 100% IR reflective or less, about 99% IR reflective or less, or about 98% IR reflective or less. For example, the emissivity range may be about 0.01 or more or about 0.20 or less, or 99% to about 80% IR reflective, respectively. Emissivity may change over time as oil, dirt, degradation, and the like may impact the fibers in the application.

Other coatings may be applied to the fibers, metallized or not, to achieve desired properties. Oleophobic and/or hydrophobic treatments may be added. Flame retardants may be added. A corrosion resistant coating may be applied to the metalized fibers to reduce or protect the metal (e.g., aluminum) from oxidizing and/or losing reflectivity. IR reflective coatings not based on metallization technology may be added.

One or more of the layers of the fibrous structure may include a binder or binder fibers. Binder may be present in one or more layers of the fibrous structure in an amount of about 40 percent by weight or less of the layer, about 30 percent by weight or less, about 25 percent by weight or less, or about 15 percent by weight or less. One or more of the layers of the fibrous structure may be substantially free of binder. One or more of the layers of the fibrous structure may be entirely free of binder. While referred to herein as fibers, it is also contemplated that the binder could be generally powder-like, spherical, or any shape capable of being received within interstitial spaces between other fibers (e.g., organic and/or inorganic fibers) and capable of binding one or more of the layers of the fibrous structure together. The binder may have a softening and/or melting temperature of about 180° C. or greater, about 200° C. or greater, about 225° C. or greater, about 230° C. or greater, or even about 250° C. or greater. The fibers may be high-temperature thermoplastic materials. The fibers may include one or more of polyamideimide (PAI); high-performance polyamide (HPPA), such as Nylons; polyimide (PI); polyketone; polysulfone derivatives; polycyclohexane dimethyl-terephthalate (PCT); fluoropolymers; polyetherimide (PEI); polybenzimidazole (PBI); polyethylene terephthalate (PET); polybutylene terephthalate (PBT); polyphenylene sulfide; syndiotactic polystyrene; polyetherether ketone (PEEK); polyphenylene sulfide (PPS), polyether imide (PEI); and the like. one or more of the layers of the fibrous structure may include polyacrylate and/or epoxy (e.g., thermoset and/or thermoplastic type) fibers. one or more of the layers of the fibrous structure may include a multi-binder system. one or more of the layers of the fibrous structure may include one or more sacrificial binder materials and/or binder materials having a lower melting temperature than other fibers, such as organic and/or inorganic fibers.

One or more of the layers of the fibrous structure may include a plurality of bi-component fibers. The bi-component fibers may be a thermoplastic lower melt bi-component fiber. The bi-component fibers may have a lower melting temperature than the other fibers within the mixture (e.g., a lower melting temperature than common or staple fibers). The bi-component fiber may be of a flame-retardant type (e.g., formed from or including flame retardant polyester). The bi-component fibers may enable one or more of the layers of the fibrous structure to be air laid or mechanically carded, lapped, needlepunched, and/or fused in space as a network so that the material may have structure and body and can be handled, laminated, fabricated, installed as a cut or molded part, or the like to provide insulation properties, acoustic absorption, or both. The bi-component fibers may include a core material and a sheath material around the core material. The sheath material may have a lower melting point than the core material. The web of fibrous material may be formed, at least in part, by heating the material to a temperature to soften the sheath material of at least some of the bi-component fibers. The temperature to which one or more of the layers of the fibrous structure is heated to soften the sheath material of the bi-component may depend upon the physical properties of the sheath material. The bi-component fibers may be formed of short lengths chopped from extruded bi-component fibers. The bi-component fibers may have a sheath-to-core ratio (in cross-sectional area) of about 15% or more, about 20% or more, or about 25% or more. The bi-component fibers may have a sheath-to-core ratio of about 50% or less, about 40% or less, or about 35% or less.

The fibers of one or more of the layers of the fibrous structure may be blended or otherwise combined with suitable additives such as other forms of recycled waste, virgin (non-recycled) materials, binders, fillers (e.g., mineral fillers), adhesives, powders, thermoset resins, coloring agents, flame retardants, longer staple fibers, etc., without limitation. Any, a portion, or all of the fibers used in one or more of the layers of the fibrous structure could be of the low flame and/or smoke emitting type (e.g., for compliance with flame and smoke standards for transportation).

The fibrous structure may include a plurality of layers. One or more of the layers may include any of the fibers described herein. One or more of the layers may be free of fibers (e.g., a foil, film, adhesive, or the like). The layers may provide desired properties or characteristics. The layers, or combinations thereof, may be selected to achieve particular results. The layers may provide enhanced properties together than each layer would provide separately. Each layer of the fibrous structure may be a different material. The fibrous structure may have some layers that are the same. The fibrous structure may have layers with similar or same components but different densities, thicknesses, weight of material, method of distributing the fibers (e.g., lapping vs needle punching), the like, or combination thereof. The fibrous structure may have layers that are different. Each layer of the fibrous structure may be different from the layer directly adjacent. The fibrous structure may have one or more layers directly adjacent to another layer, where the layers are the same.

The fibrous structure may include a metallic or metallized layer. The layer may be located on an outermost surface of the fibrous structure to provide heat and/or infrared reflection. The metallic or metallized layer may be adapted to face the item to be insulated. The metallic or metallized layer may be adapted to face away from the item to be insulated (i.e., the outermost layer of the fibrous structure when assembled). The fibrous structure may include two or more metallic or metallized layers. The metallic or metallized layer may offer resistance to weathering, mold, UV, extreme environmental conditions, or a combination thereof. The material may withstand demanding temperature and humidity conditions. The material may act to seal in temperatures to reduce temperature fluctuations to which the item to be insulated is exposed. The metallic or metallized layer may act as a barrier (e.g., moisture barrier, chemical barrier, flame barrier, or the like). The metallic or metallized layer may provide support and/or reinforcement to the fibrous structure or one or more layers thereof. The metallic or metallized layer may provide protection to other layers of the fibrous structure (e.g., by providing puncture resistance). The metallic or metallized layer may resist failure from common sources of degradation, including moisture, UV rays, extreme temperature conditions, and chemicals.

The metallic or metallized layer may be a foil, coating, sheet, mesh, deposition of metal atoms on a surface of a material, or the like. The metallic or metallized layer may be reinforced (e.g., with ribs). The metallic or metallized layer may be reinforced, for example, by wire, fibers, additives, mesh, or the like. The metallic or metallized layer may be reinforced with a fiberglass mesh. The fiberglass mesh may, for example, be a backing to a metallic facing or may be embedded within the metallic layer, or may be located between two or more metallic sheets, coatings, or the like. The metallic or metallized layer may be formed of a metal or metal alloy. For example, the metallic or metallized layer may be formed of aluminum (e.g., an aluminum foil). The metallic or metallized layer may be considered a single layer, even if it includes multiple components, such as an aluminum foil and a fiberglass mesh. The metallic or metallized layer may be considered more than one layer if counting each component separately.

The metallic or metallized layer may have a thickness sufficient to provide the desired properties or protection. The metallic or metallized layer may have a thickness of about 10 micrometers or greater, about 25 micrometers or greater, or about 50 micrometers or greater. The metallic or metallized layer may have a thickness of about 150 micrometers or less, about 125 micrometers or less, or about 100 micrometers or less.

The fibrous structure may include one or more layers having fibers capable of withstanding high temperatures. The fibrous structure may include one or more layers having fibers that do not burn, melt, soften, and/or drip. The fibers may provide effective protection against fire and/or heat. The fibrous structure may include one or more layers having fibers that are resistant to many or most solvents and chemicals. The fibrous structure may include one or more layers having fibers with a low permeability to gases.

Fibers capable of withstanding high temperatures may be organic fibers. The organic fibers may be present in one or more layers in an amount of about 50 wt % or greater of the layer, about 70 wt % or greater of the layer, or about 75 wt % or greater of the layer. The organic fibers may be present in an about of about 100 wt % or less of the layer. The fibers may be formed of or include a synthetic thermoplastic polymer resin. For example, the fibers may be polyacrylonitrile fibers. The polyacrylonitrile fibers may be oxidized polyacrylonitrile fibers, such as Ox-PAN, OPAN, or PANOX.

The one or more layers may include polyacrylonitrile fibers or oxidized polyacrylonitrile fibers in the layer in an amount of about 50 wt % or greater of the layer, about 70 wt % or greater, or about 75 wt % or greater. The one or more layers may include polyacrylonitrile fibers or oxidized polyacrylonitrile fibers in an amount of about 100 wt % or less. The layer may include other components, such as other thermoplastic polymer materials. The layer may comprise polyester fibers, such as polyethylene terephthalate (PET), polybutylene terephthalate (PBT), and co-polyester/polyester (CoPET/PET) adhesive bi-component fibers. The fibers may include olefin, polyamide, polyetherketone (PEK), polyetheretherketone (PEEK), polyether sulfone (PES), or other polymeric fibers. The fibers may include mineral or ceramic fibers. For example, the material may contain about 70 wt % polyacrylonitrile fibers or about 70 wt % oxidized polyacrylonitrile fibers and up to about 30 wt % PET.

The one or more layers including these fibers may have a temperature resistance of up to and including about 200° C., up to and including about 400° C., or up to and including about 450° C., or even higher.

The fibers, such as polyacrylonitrile fibers (which may be or may include oxidized polyacrylonitrile fibers), may be used to form a nonwoven layer. The fibers forming the nonwoven layer may be formed into a nonwoven web using nonwoven processes including, for example, blending fibers, carding, lapping (e.g., vertical lapping, cross-lapping), air laying, mechanical formation, needle punching, or a combination thereof. The layer may have a weight of about 100 g/m² or greater, about 200 g/m² or greater, or about 400 g/m² or greater. The layer may have a weight of about 1000 g/m² or less, about 750 g/m² or less, or about 500 g/m² or less.

The fibrous structure may include two or more layers having polyacrylonitrile fibers. The layers may be the same relative to each other. The layers may be different relative to each other (e.g., by structure of the nonwoven material, orientation of the fibers, weight of the material, or the like). The fibrous structure may include some layers that are the same and some layers that are different.

For example, a fibrous structure may include one or more polyacrylonitrile or oxidized polyacrylonitrile fiber layers formed by needle punching. The needlepunched layer may have a weight of about 200 g/m². The needlepunched layer may have a weight of about 400 g/m². The fibrous structure may include one or more polyacrylonitrile or oxidized polyacrylonitrile fiber layers formed by cross-lapping. The cross-lapped layer may have a weight of about 400 g/m². The fibrous structure may include two or more needlepunched layers of polyacrylonitrile or oxidized polyacrylonitrile fibers. The fibrous structure may include two or more cross-lapped layers of polyacrylonitrile or oxidized polyacrylonitrile fibers. The fibrous structure may include a combination of needlepunched and cross-lapped polyacrylonitrile or oxidized polyacrylonitrile fiber layers.

The fibrous structure may include one or more layers having inorganic fibers or fibers made from inorganic materials. These fibers may be capable of withstanding high temperatures, provide thermal stability, or both. One or more layers or the fibers therein may be non-combustible. One or more layers or the fibers therein may have high-porosity, provide acoustic absorption, or a combination thereof. One or more layers or the fibers therein may exhibit high temperature duration, low heat shrinkage, low heat loss, or a combination thereof.

One or more layers of the fibrous structure having inorganic fibers may have up to 100 wt % of the layer inorganic fibers. One or more layers of the fibrous structure may have inorganic fibers in an amount of about 50 wt % or greater of the layer, about 70 wt % or greater, or about 90 wt % or greater.

The fibrous structure may include one or more layers including E-glass. The fibers forming the E-glass layer may resist thermal expansion, which may keep the shape and size of the layer constant despite exposure to temperature fluctuations. The fibers may provide high strength and stiffness at low weight. The fibers may exhibit low values for dielectric constant, dielectric loss, or both. The fibers, or layer formed by the fibers, may have a temperature resistance up to and including about 500° C., about 600° C., or about 640° C., or even higher.

The E-glass layer may include any of silica, alumina, calcium oxide (CaO), boron oxide (B₂O₃). The E-glass inorganic materials may be enveloped by a resin, such as an epoxy resin. The layer may be formed by any suitable process, including but not limited to needle punching to form a mat.

An E-glass layer may have a thickness of about 0.5 mm or greater, about 1 mm or greater, or about 2 mm or greater. An E-glass layer may have a thickness of about 6 mm or less, about 5 mm or less, or about 4 mm or less. For example, the E-glass layer may be about 3 mm thick.

The E-glass fibers may be free of boron oxide. Such boron-free material is referred to as E-CR glass. The E-CR glass may provide acid and/or chemical resistance. The E-CR glass may provide increased temperature resistance. The fibers, or layer formed by the fibers, may have a temperature resistance up to and including about 600° C., about 650° C., or about 700° C., or even higher. An E-CR glass layer may be formed by any suitable process, including but not limited to needle punching to form a mat and/or wetlaying. An E-CR glass layer may have a thickness of about 0.5 mm or greater, about 1 mm or greater, or about 2 mm or greater. An E-CR glass layer may have a thickness of about 6 mm or less, about 5 mm or less, or about 4 mm or less. For example, the E-CR glass layer may be about 3 mm thick.

The fibrous structure may include one or more wetlaid layers. A wetlaid layer may be formed by a dilute slurry of liquid (e.g., water), fibers, and optionally binder, which is deposited on a moving wire screen. The liquid is drained and the fibers form a web. The fibers of the wetlaid layer may be fibers that impart a desired temperature resistance to the layer. For example, the fibers and/or wetlaid layer may be capable of withstanding temperatures of about 300° C. or greater, about 400° C. or greater, or about 600° C. or greater during continuous exposure. The fibers and/or wetlaid layer may be capable of withstanding temperatures of about 1000° C. or less, about 750° C. or less, or about 700° C. or less during continuous exposure. For example, a wetlaid layer or fibers thereof may resist temperatures of about 600° C. to about 700° C. (e.g., about 650° C.) or less during continuous exposure.

The wetlaid layer may include glass fibers. The wetlaid layer may include E-glass fibers. The E-glass fibers may be E-CR fibers.

The wetlaid layer may include binder. The wetlaid layer may include thermoplastic binder. The wetlaid layer may include acrylic binder. The binder may be present in an about of about 5% by weight or greater, about 7% by weight or greater, or about 10% by weight or greater. The binder may be present in an amount of about 20% by weight or less, about 15% by weight or less or about 12% by weight or less.

The wetlaid layer may have a weight of about 10 g/m² or greater, about 25 g/m² or greater, or about 40 g/m² or greater. The wetlaid layer may have a weight of about 400 g/m² or less, about 300 g/m² or less, or about 250 g/m² or less. For example, the wetlaid layer may have a weight of about 40 g/m² to about 250 g/m² or about 80 g/m² to about 200 g/m².

The fibrous structure may include one or more layers having fibers forming a high-silica nonwoven material. The layer may be formed by any suitable process, including but not limited to needle punching to form a mat. The layer may be formed by silica fibers in any amount up to 100 wt % of the layer. The fibers, or layer formed by the fibers, may have a temperature resistance up to and including about 900° C., about 1000° C., about 1100° C., or even higher.

The fibrous structure may include one or more layers of a ceramic blanket. The ceramic blanket layer may provide improved handling strength, enhanced thermal properties, or both. The ceramic blanket layer may exhibit outstanding insulating properties at elevated temperatures. The ceramic blanket layer may have excellent thermal stability. The ceramic blanket layer may have a temperature resistance up to and including about 1000° C., about 1200° C., or about 1300° C., or even greater. The ceramic blanket may be flexible, easy to cut and shape, or a combination thereof. The ceramic blanket may have good resistance to tearing. The ceramic blanket may exhibit low heat storage. The ceramic blanket may provide sound absorption. The ceramic blanket layer may be formed by any suitable process, including but not limited to needle punching.

The ceramic blanket may be substantially free of binder (e.g., about 1 wt % or less of the layer). The ceramic blanket may be entirely free of binder. The ceramic blanket may be formed of inorganic materials in an amount up to and including about 100 wt % of the layer. For example, the ceramic blanket may comprise silicon dioxide (SiO₂), calcium oxide (CaO), and magnesium oxide (MgO).

The fibrous structure may include one or more layers of fiberglass. For example, one or more of the layers may be black glass cloth. The fiberglass may impart high temperature resistance and thermal stability. The fiberglass layer may provide abrasion resistance. The fiberglass layer may be resistant to tearing. The fiberglass layer may exhibit solvent resistance.

The nonwoven materials of the present teachings may be formed using any method that produces a material having the desired properties. This is including, but not limited to, carding, air laying, wet laying, spun-bonding, melt-blowing, electro-spinning, lapping (e.g., vertically lapping, cross-lapping), needle punching, wetlaid processes, or any combination thereof.

The present teachings contemplate any combination of layers described herein, including but not limited to: a metallic layer, such as an aluminum or aluminized layer; a polyacrylonitrile fiber-based or oxidized polyacrylonitrile fiber-based layer (formed by any process, such as needle punching, a wetlaid process, and/or lapping, such as cross-lapping); and inorganic fiber layer formed from E-glass, E-CR glass, a high silica nonwoven, fiberglass, ceramic blanket. One or more of the layers may be a nonwoven layer, formed from processes such as needle punching, a wetlaid process, and/or lapping.

The layers of material forming the fibrous structure may be secured together to create the finished fibrous structure. One or more layers may be bonded together by elements present in the layers. For example, binder fibers in one or more layers may serve to bond layers together. The outer layers (i.e., the sheath) of bi-component fibers in one or more layers may soften and/or melt upon the application of heat, which may cause the fibers of the individual layers to adhere to each other and/or to adhere to the fibers of other layers. Layers may be attached together by one or more lamination processes. One or more adhesives may be used to join two or more layers. The adhesives may be a powder or may be applied in strips, sheets, or as a liquid, for example. It is contemplated that the adhesives used to join two or more layers may not be included in the total count of layers. The one or more layers may be secured to each other using any other process suitable for the intended use, such as stitching, mechanical bonding, heat sealing, sonic or vibration welding, pressure welding, the like, or a combination thereof.

The total thickness of the fibrous structure may depend upon the number and thickness of the individual layers. The fibrous structure may have 2 or more layers, 3 or more layers, or 4 or more layers. The fibrous structure may have 10 or less layers, 8 or less layers, or 6 or less layers. The number of layers may be inclusive of films, adhesives, depositions of materials impacting adhesion between the layers, the like, or combination thereof. The number of layers may be exclusive of films, adhesives, depositions of materials impacting adhesion between the layers, the like, or a combination thereof. For example, if an adhesive is positioned between two fibrous layers, this could be considered two layers if the number of layers is exclusive of adhesives or three layers if the number of layers is inclusive of adhesives. Certain layers may be considered a single layer, even if there are different materials within the layer. For example, a metallized layer backed by or reinforced by a fiberglass mesh may be considered a single layer, even though the aluminum foil and fiberglass mesh are different materials. The total thickness may be about 0.5 mm or more, about 1 mm or more, or about 1.5 mm or more. The total thickness may be about 20 mm or less, about 15 mm or less, or about 12 mm or less. For example, the total thickness may be about 3 mm to about 6 mm.

The fibrous structure may be shaped or positioned to at least partially surround an item to be insulated. The fibrous structure may be thermoformed into a desired shape. The fibrous structure may be bent, folded, or otherwise situated into a desired shape. The fibrous structure may be an at least partial enclosure for a battery or a battery case. The fibrous structure may be shaped to fit within particular confines of a vehicle. For example, the fibrous structure may be shaped to fit below or within the confines of a battery cover of a vehicle. The fibrous structure may be formed from a multi-layer piece. The fibrous structure may be formed from multiple multi-layer pieces. The fibrous structure may be formed from individual pieces secured together. For example, generally planar pieces may be secured at one or more edges to form a shape capable of surrounding the item to be insulated. One or more pieces may be movable or removable to provide access to the battery at least in particular areas.

The fibrous structure may have one or more generally planar portions. The generally planar portion may be generally coplanar with a face or surface of a battery or a battery case. The generally planar portion may be located beneath or within a battery cover of a vehicle. One or more sides may extend from the generally planar portion. The sides may be shaped to fit within the confines of a battery cover. The sides may be shaped to fit around a battery or a battery case.

The fibrous structure may form a box-shape that at least partially surrounds the battery or the battery case. The battery box may have a top cover portion that is adapted to be generally coplanar with a large face of the battery or the battery case. The battery box may have one or more side cover portions that are adapted to be generally coplanar with a side of the battery. The side cover portions may be generally elongated in a similar dimension to the side of the battery to which it corresponds. One or more side cover portions may include one or more cutouts or openings to accommodate features of the battery or battery case, including but not limited to ports, wires, terminals, caps, connectors, prongs, and vents.

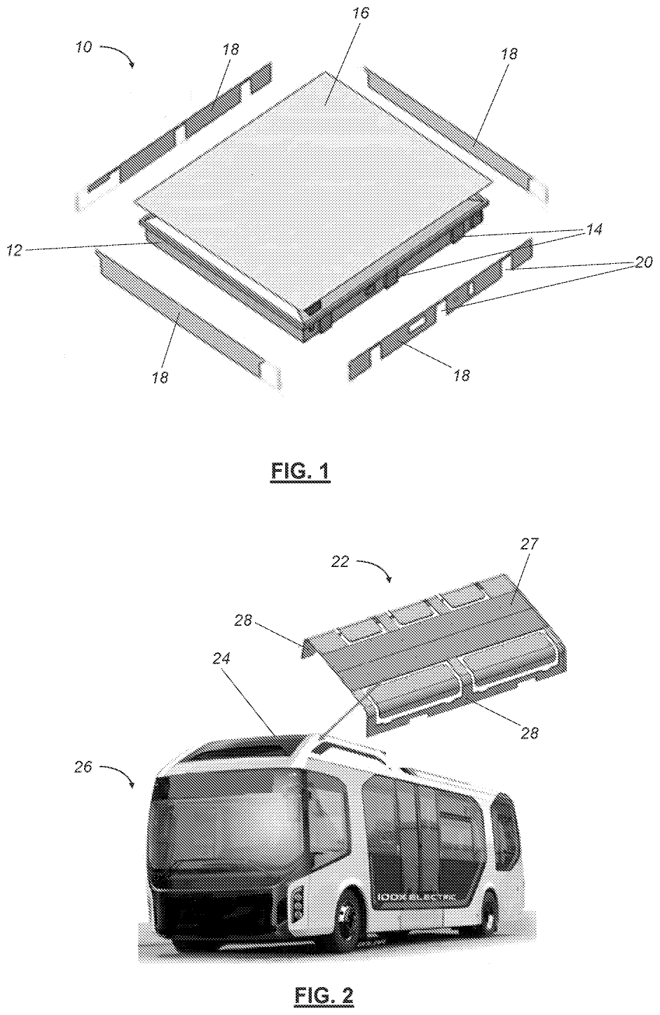

Turning now to the drawings, FIG. 1 illustrates an exploded view of an exemplary battery box assembly 10 for providing insulation to a battery 12. The assembly includes a top insulator portion 16 that is generally coplanar with a face of the battery or battery case. The assembly also includes side insulator portions 18 that are located at the sides of the battery. As the battery 12 includes features 14 that extend from or are located on the sides, one or more of the side insulator portions 18 include cutouts 20 that are generally aligned with and accommodate the features 14. Features 14 may include, but are not limited to, ports, wires, terminals, caps, connectors, prongs, vents, or the like.

FIG. 2 illustrates an exemplary battery pack thermal insulator 22. The battery pack thermal insulator is adapted to be located under a top cover 24 of a battery of an electric vehicle 26. The battery thermal insulator 22 includes a generally planar body portion 27 and side walls 28. The battery thermal insulator 22 may include one or more features that permit access to the battery, such as removable pieces, flaps, covers, openings, or the like.

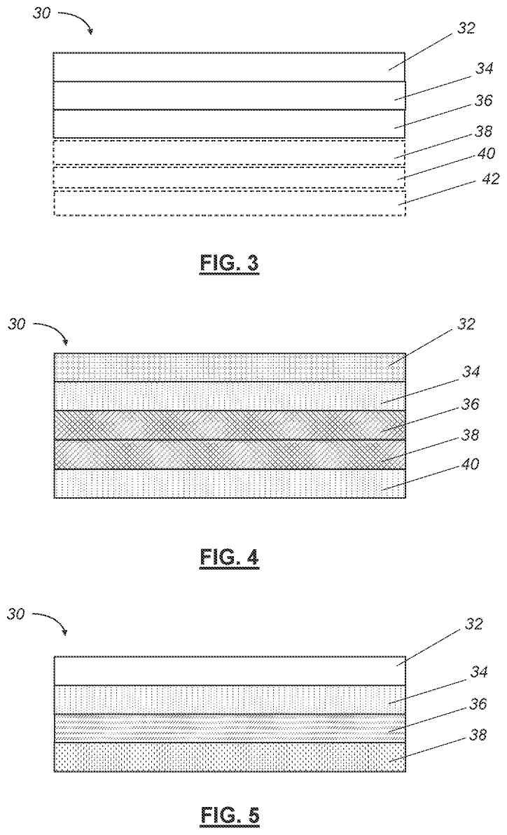

FIG. 3 is a side or cross-sectional view of an exemplary fibrous structure or multi-layer insulator material 30. The multi-layer insulator material 30 includes a top layer 32, a second layer 34, and a third layer 36. The multi-layer insulator material 30 optionally includes any of a fourth layer 38, a fifth layer 40, and a sixth layer 42.

FIG. 4 is an exemplary multi-layer insulator material 30. The top layer 32 is shown as a reinforced aluminum foil. The second layer 34 is a needlepunched layer including oxidized polyacrylonitrile fibers. The third layer 36 and fourth layer 38 are cross-lapped layers. The fifth layer 40 is a needlepunched layer including oxidized polyacrylonitrile fibers.

In a nonlimiting example, the construction may be an aluminum foil (e.g., reinforced aluminum foil), a needlepunched layer including oxidized polyacrylonitrile fibers with a weight of about 200 g/m², two cross-lapped layers each having a weight of about 400 g/m², and a needlepunched layer including oxidized polyacrylonitrile fibers with a weight of about 200 g/m².

FIG. 5 is an exemplary multi-layer insulator material 30. The top layer 32 is an aluminum foil. The second layer 34 is a needlepunched layer including oxidized polyacrylonitrile fibers. The third layer 36 is a ceramic blanket. The fourth layer 38 is a high-silica nonwoven.

In a nonlimiting example, the construction may be an aluminum foil that is about 60 microns thick, a needlepunched layer including oxidized polyacrylonitrile fibers with a weight of about 200 g/m², a 6 mm ceramic blanket, and a high-silica nonwoven.

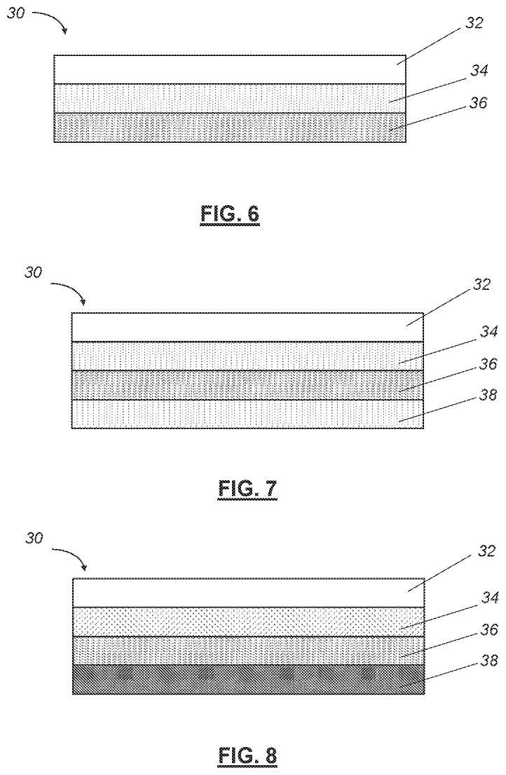

FIG. 6 is an exemplary multi-layer insulator material 30. The top layer 32 is an aluminum foil. The second layer 34 is a needlepunched layer including oxidized polyacrylonitrile fibers. The third layer 36 is an E-glass material.

In a nonlimiting example, the construction may be an aluminum foil that is about 60 microns thick, a needlepunched layer including oxidized polyacrylonitrile fibers with a weight of about 400 g/m², and an E-glass layer.

FIG. 7 is an exemplary multi-layer insulator material 30. The top layer 32 is an aluminum foil. The second layer 34 is a needlepunched layer including oxidized polyacrylonitrile fibers. The third layer 36 is an E-glass material. The fourth layer 38 is a needlepunched layer including oxidized polyacrylonitrile fibers.

In a nonlimiting example, the construction may be an aluminum foil that is about 60 microns thick, a needlepunched layer including oxidized polyacrylonitrile fibers with a weight of about 400 g/m², an E-glass layer, and a needlepunched layer including oxidized polyacrylonitrile fibers with a weight of about 400 g/m².

FIG. 8 is an exemplary multi-layer insulator material 30. The top layer 32 is an aluminum foil. The second layer 34 is an E-CR glass material. The third layer 36 is an E-glass material. The fourth layer 38 is a black glass cloth.

In a nonlimiting example, the construction may be an aluminum foil that is about 60 microns thick, an E-CR glass material layer, an E-glass material layer, and a black glass cloth layer with a thickness of about 0.5 mm.

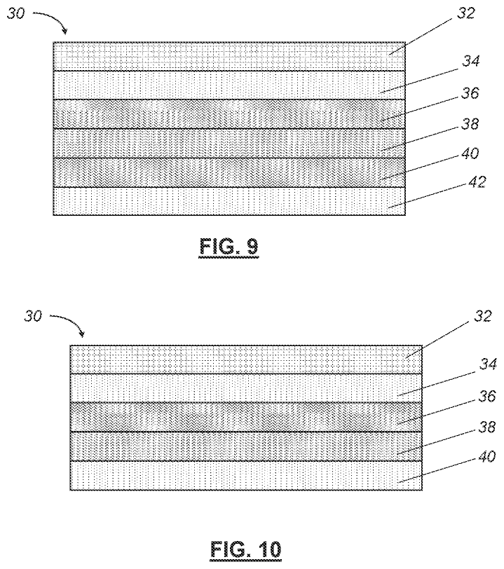

FIG. 9 is an exemplary multi-layer insulator material 30. The top layer 32 is reinforced aluminum foil. The second layer 34 is a needlepunched layer including oxidized polyacrylonitrile fibers. The third layer 36 is a wetlaid layer. The fourth layer 38 is an E-glass material. The fifth layer 40 is a wetlaid layer. The sixth layer 42 is a needlepunched layer including oxidized polyacrylonitrile fibers. Each wetlaid layer may have a weight of about 80 gsm or greater. Each wetlaid layer may have a weight of about 200 gsm or less. One or more of the wetlaid layers may be formed with E-CR glass material.

In a nonlimiting example, the construction may be a reinforced aluminum layer, where the layer is reinforced with a fiberglass mesh, a needlepunched layer including oxidized polyacrylonitrile fibers with a weight of about 200 g/m², a wetlaid layer with E-CR glass material having a weight of about 80 g/m², a layer formed of E-glass material having a thickness of about 3 mm, a wetlaid layer with E-CR glass material having a weight of about 80 g/m², and a needlepunched layer including oxidized polyacrylonitrile fibers with a weight of about 200 g/m².

Tests performed on this specific material using ASTM C518-17 are provided in Table 1.

TABLE 1

| Mean | Delta | Thermal | Thermal |
|---|---|---|---|
| Temperature | Temperature | Conductivity | Resistance |
| (° C.) | (° C.) | (W/m-k) | (M²*k/w) |
| 22.50 | 10.00 | 0.035785 | 0.357689 |

FIG. 10 is an exemplary multi-layer insulator material 30. The top layer 32 is a reinforced aluminum foil. The second layer 34 is a needlepunched layer including oxidized polyacrylonitrile fibers. The third layer 36 is a wetlaid layer. The fourth layer 38 is an E-glass material. The fifth layer 40 is a needlepunched layer including oxidized polyacrylonitrile fibers. The wetlaid layer may be formed of an E-CR glass material.

In a nonlimiting example, the construction may be a reinforced aluminum layer, where the layer is reinforced with a fiberglass mesh, a needlepunched layer including oxidized polyacrylonitrile fibers with a weight of about 200 g/m², a wetlaid layer with E-CR glass material having a weight of about 80 g/m², a layer formed of E-glass material having a thickness of about 3 mm, and a needlepunched layer including oxidized polyacrylonitrile fibers with a weight of about 200 g/m².

Tests performed on this specific material using ASTM C518-17 are provided in Table 2.

TABLE 2

| Mean | Delta | Thermal | Thermal |
|---|---|---|---|
| Temperature | Temperature | Conductivity | Resistance |
| (° C.) | (° C.) | (W/m-k) | (M²*k/w) |
| 22.50 | 10.00 | 0.034685 | 0.343088 |

The figures and specific examples are not intended to serve as limiting. While the figures provide specific examples of materials and arrangements thereof, it is contemplated that these materials may be used in other configurations or arrangements or in other combinations. These combinations are also within the scope of the teachings.

Parts by weight as used herein refers to 100 parts by weight of the composition specifically referred to. Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32, etc. are expressly enumerated in this specification. For values which are less than one, one unit is considered to be 0.0001, 0.001, 0.01, or 0.1 as appropriate. These are only examples of what is specifically intended and all possible combinations of numerical values between the lowest value, and the highest value enumerated are to be expressly stated in this application in a similar manner. Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

1. An article comprising:
three or more layers, the layers comprising:
a. a metallic facing; and
b. one or more nonwoven layers;
wherein one or more of the layers is a needlepunched layer;
wherein each nonwoven layer has a temperature resistance of about 400° C. or greater; and
wherein the article is adapted to provide insulation for a battery.

2. The article of claim 1, wherein the metallic facing is an aluminum foil or a reinforced aluminum foil.

3. (canceled)

4. The article of claim 1, wherein one or more of the nonwoven layers comprises organic fibers in an amount of about 50 wt % or greater and about 100 wt % or less.

5.-8. (canceled)

9. The article of claim 1, wherein one or more of the nonwoven layers comprises inorganic fibers in an amount of about 50 wt % or greater and about 100 wt % or less.

10.-13. (canceled)

14. The article of claim 1, wherein one or more of the nonwoven layers comprises polyacrylonitrile fibers, oxidized polyacrylonitrile fibers, or both.

15. The article of claim 1, wherein the article comprises six or fewer layers.

16. (canceled)

17. The article of claim 1, wherein one or more layers of the article is different from a layer directly adjacent.

18. The article of claim 1, wherein the layers include any of the following in any combination: a metallized layer, a layer formed of oxidized polyacrylonitrile fibers, a needlepunched layer, a cross-lapped layer, a layer formed of inorganic fibers, a layer formed of organic fibers, an E-glass layer, an E-CR glass layer, a wetlaid layer, a high silica nonwoven layer, a ceramic blanket, a black glass cloth layer, a vertically lapped layer.

19. The article of claim 18, wherein the article comprises:
a. an aluminum foil layer;
b. one or more needlepunched layers including oxidized polyacrylonitrile fibers; and
c. one or more cross-lapped layers including oxidized polyacrylonitrile fibers.

20. The article of claim 18, wherein the article comprises:
a. an aluminum foil layer;
b. one or more needlepunched layers including oxidized polyacrylonitrile fibers;
c. one or more ceramic blanket layers; and
d. one or more high-silica nonwoven layers.

21. The article of claim 18, wherein the article comprises:
a. an aluminum foil layer;
b. one or more needlepunched layers including oxidized polyacrylonitrile fibers; and
c. one or more E-glass layers.

22. The article of claim 18, wherein the article comprises:
a. an aluminum foil layer;
b. one or more E-glass layers;
c. one or more E-CR glass layers; and
d. one or more black glass cloth layers.

23. The article of claim 18, wherein the article comprises:
a. an aluminum foil layer;
b. one or more needlepunched layers including oxidized polyacrylonitrile fibers;
c. one or more wetlaid layers; and
d. one or more E-glass layers.

24. The article of claim 1, wherein at least one of the layers has a temperature resistance of about 450° C. or greater and about 800° C. or less.

25.-28. (canceled)

29. An insulation material for an electric vehicle battery comprising the article of claim 1.

30. (canceled)

31. The insulation material of claim 29, wherein the insulation material includes a top cover extending generally co-planar with a face of the battery.

32. The insulation material of claim 29, wherein the insulation material includes one or more sides extending generally co-planar with a side of the battery.

33. The insulation material of claim 32, wherein one or more sides of the insulation material includes one or more cutouts to accommodate features of the battery.

34. The insulation material of claim 29, wherein the insulation material is adapted to be located under a top cover of the battery.

35. The insulation material of claim 29, wherein the insulation material is a passive insulation product used in combination with an active temperature control system to maintain proper battery temperature, wherein proper battery temperature is within about 50° C.

36. (canceled)
